(19) United States
(12) Patent Application Publication
(10) Pub. No.: US 2004/0205743 A1
(43) Pub. Date: Oct. 14, 2004

(54) Data processor, printing system and method of setting control for the driver software

(76) Inventor: Yoshinori Sugahara, Kyoto-shi (JP)

Correspondence Address: BURNS DOANE SWECKER & MATHIS L L P, POST OFFICE BOX 1404, ALEXANDRIA, VA, 22313-1404, US

(21) Appl. No.: 09/789,501

(22) Filed: Feb. 22, 2001

(30) Foreign Application Priority Data
Feb. 22, 2000 (JP) 2000-44284

(51) Int. Cl. G06F 9/455

(52) U.S. Cl. 717/168

(57) ABSTRACT

There is provided a data processor that may reduce printing failures, which are caused when different printing forms are set for each printer driver, and may eliminate complexity in setting the same printing form on a plurality of printer drivers. In said data processor to which a plurality of driver software are installed, which may control external devices, and may make data based on predetermined conditions for output to the external devices, conditions for reference at making the data are set on each of the driver software; set information on the set conditions is stored in a common storage area; and the set information stored in the common storage area is read at using each of the driver software.

This application is based on application No. 2000-044284 filed in Japan, the contents of which is hereby incorporated by reference.

### BACKGROUND OF THE INVENTION

The present invention relates to a data processor, a printing system, a method of setting control for the driver software and a storage medium storing a setting control program for the driver software.

Recently, there have been more cases where a plurality of printers on networks are used by one personal computer (hereinafter, called as PC), along with development of networks. The PC is required to install a plurality of printer drivers corresponding to various kinds of printers in order to recognize a plurality of printers. Various kinds of printing forms, such as layout printing (2 in 1, 4 in 1, and so on), booklet printing, and position shift printing, may be respectively set on the printer drivers. In general, information that is set on each printer driver and relative to the printing forms, has been conventionally configured to be kept in individual storage areas for each printer driver.

However, in the conventional methods, when a user expect to perform the same printing form with the previous one after switching the current printer to another one, there have been cases where setting for a printing form on the printer driver newly called is different from the previous one, and an unintended printing form is used, as the information which is set on each printer driver, and relative to the printing forms, is kept in individual storage areas. Therefore, the same printing form has been required to be set on all the printer drivers when a unified printing form is used on a plurality of printer drivers installed in one PC.

And, the same printing form has been required to be set on all the printer drivers when a unified printing form is also used in a printing system comprising a plurality of PCs and printers on, for example, local area network constructed in offices.

Thereby, the present invention has been made for solution of the above technical problems, and its object is to provide a data processor, a printing system, and, a method of setting control for the driver software; and a storage medium storing programs for setting control for the driver software to reduce printing failures caused when different printing forms are set for each printer driver, and for elimination of complexity in setting the same printing form on a plurality of printer drivers.

### SUMMARY OF THE INVENTION

In an aspect of the present invention, there is provided a data processor to which a plurality of driver software are installed, which may control external devices, and may make data, based on predetermined conditions, for output to the external devices. The data processor comprises a setting means for setting conditions for reference at making the data on each of the driver software; a storage device for storage of set information on the conditions set by the setting means; and a controller for control to store set information on each of the driver software in the storage area which is commonly used by a plurality of driver software in the storage device, and to read for use of each of the driver software the set information stored in the storage area which is commonly used. Moreover, the storage device may comprise a common storage area for storage of set information applied for all the driver software; and individual storage areas for storage of set information applied for each driver software. In addition, the setting means may comprise a selector for selecting set information to be stored in the common storage area for a plurality of conditions which may be set on the driver software. Furthermore, the data processor may comprise a watcher for watching a spooler which is installed according to each of the driver software, and temporarily stores job data to be output to the external devices through the driver software; and a conversion means for converting the job data, which the watcher acquires from the spooler, according to the set information stored in the storage devices. And, the external device may be a printing device, and the driver software may be driver software for the printer.

In an another aspect of the present invention, there is provided a printing system comprising: a network server to which a plurality of driver software are installed, for control of a printing device, and for making, based on predetermined conditions, data to be output to the printing device; a plurality of data processors to which the driver software is installed respectively; and a printing device performing printing of the job data transmitted from the data processor. The network server transmits set information on the driver software to the data processor at using driver software in the data processor. The data processor may comprise a requesting device to request at an arbitrary timing the set information on the driver software in the network server, and the network server may transmit requested set information to the data processor, responding to requests by the requesting device. Furthermore, the network server may transmit the set information to a plurality of the data processors.

In a further another aspect of the present invention, there is provided a method of setting control for driver software in a data processor to which a plurality of driver software are installed, for control of external devices, and for making, based on predetermined conditions, data to be output to the external devices, the method comprising steps of: allowing to set conditions for reference at making the data on each of the driver software; storing set information on the set condition in a storage area commonly used for a plurality of the driver software; and reading the set information stored in the storage area commonly used at use of each of the driver software. In addition, the method may comprise a step of selecting set conditions stored in the storage area commonly used, among a plurality of setting conditions. Furthermore, the method may comprise steps of: watching a spooler which temporarily stores job data to be output to the external devices through the driver software; and converting the job data acquired from the spooler according to the set information stored in the storage area.

In still another aspect of the present invention, there is provided a method of setting control for driver software in a printing system comprising a network server to which the driver software is installed, for control of a printing device, and for making, based on predetermined conditions, data to be output to the printing device; and the printing device to perform printing of the job data transmitted from the data processor. The method comprises steps of: on said network server, transmitting the set information for the driver software installed in the network server to the data processor; and on said data processor, performing to set conditions for the driver software in the data processor based on the set information.

In a still further aspect of the present invention, there is provided a storage medium storing a setting control program for driver software executed in the data processor to which a plurality of driver software are installed, for control of external devices, and for making, based on predetermined conditions, data to be output to the external devices. The setting control program comprises steps of allowing to set conditions for reference at making the data on each of the driver software; storing set information on the set conditions in a storage area commonly used for a plurality of the driver software; and reading the set information stored in the storage area commonly used at use of the driver software. In addition, the setting control program may comprise a step of selecting set conditions stored in the storage area commonly used, among a plurality of setting conditions. Furthermore, the setting control program may comprise steps of; watching a spooler which temporarily stores job data to be output to the external devices through the driver software; and converting the job data acquired from the spooler according to the set information stored in the storage area.

In still further another aspect of the present invention, there is provided a storage medium storing a setting control program for driver software executed in a printing system comprising: a network server to which a driver software is installed, for control of a printing device, and for making, based on predetermined conditions, data to be output to the printing device; a plurality of data processors to which said driver software is installed respectively; a printing device for performing to print the job data transmitted from the data processor. The setting control program comprises steps of: reading of the set information for driver software installed in the network server; and transmitting the read set information for the driver software from the network server to the data processor.

### BRIEF DESCRIPTION OF THE DRAWINGS

FIG. 1 shows a schematic explanatory drawing of a network comprising data processors according to an embodiment of the present invention;

FIG. 2 shows an explanatory drawing of each printer driver in a client PC on the network, and a configuration relative to the operations of those drivers;

FIG. 3 shows a flow chart for acquisition processing of set information on a printer driver in the client PC;

FIG. 4 shows an explanatory drawing of printer drivers in a client PC according to an embodiment 2 of the present invention, and a configuration relative to the operations of the drivers;

FIG. 5 shows a setting screen of printing forms which are individually reflected on each printer driver, and the screen is provided as a user interface by a user I/F control processing part of each printer driver according to the embodiment 2 of the present invention;

FIG. 6 shows a setting screen of printing forms which are reflected on all the printer drivers, and the screen is provided as a user interface by a user I/F control processing part of each printer driver according to the embodiment 2 of the present invention;

FIG. 7 shows a flow chart for acquisition processing of the set information on a printer driver in a client PC according to the embodiment 2 of the present invention;

FIG. 8 shows an explanatory drawing of printer drivers in client PCs according to an embodiment 3 of the present invention;

FIG. 9 shows a flow chart for conversion processing of job data made on a printer driver in a client PC according to the embodiment 3 of the present invention;

FIG. 10 shows an explanatory drawing of a printer driver in a client PC according to an embodiment 4 of the present invention and a configuration relative to the operations of the driver;

FIG. 11 shows an explanatory drawing of a printer driver in a client PC according to the embodiment 4 of the present invention, and a configuration relative to the operations of the driver;

FIG. 12 shows a flow chart for supplying processing of the set information on the printer driver in a server PC according to the embodiment 4 of the present invention;

FIG. 13 shows a flow chart for acquisition processing of the set information on a printer driver in a server PC according to the embodiment 4 of the present invention;

FIG. 14 shows an explanatory drawing of a printer driver 70 in a client PC according to the variation of the embodiment 4 of the present invention, and a configuration relative to the operations of the driver;

FIG. 15 shows a view of a printer driver in a server PC according to the variation of the embodiment 4 of the present invention;

FIG. 16 shows a flow chart for acquisition processing of the set information on a printer driver in a server PC according to the variation of the embodiment 4 of the present invention; and

FIG. 17 shows a flow chart for supplying processing of the set information on a printer driver in a server PC according to the variation of the embodiment 4 of the present invention.

### DETAILED DESCRIPTION OF THE INVENTION

Hereinafter, embodiments according to the present invention will be described, referring to the appended drawings.

Embodiment 1

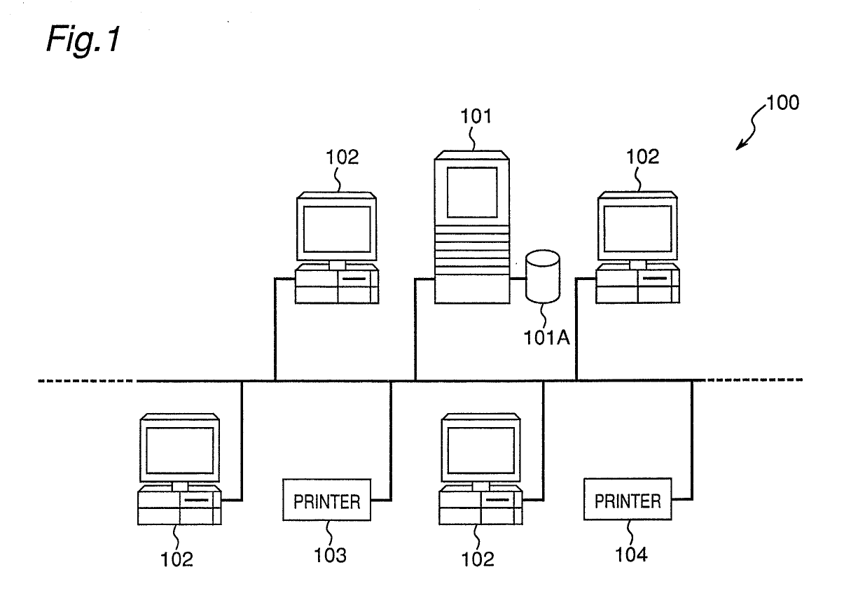

FIG. 1 shows a schematic explanatory drawing of a network comprising image formation devices (hereinafter, called as a printers) according to the embodiment 1 of the present invention. The network 100 comprises: a master computer 101 (hereinafter, called as a server PC) for execution of jobs, which are required by control, management, and so on of the whole network, such as file retrieving; a plurality of slave computers 102 (hereinafter, called as client PCs); first and second printers 103, and 104 for output of data, which are transmitted from the client PCs 102, as printed characters. A data base 101A for systematic management of various kinds of data is attached to the server PC 101. Client PCs 102 have access to the data base 101A, as required for reading or writing the data.

In the network 100, a plurality of client PCs 102 on the network 100 use the first and second printers 103 and 104 in common. The printers 103, and 104 sequentially output, for example, data made by respective client PC 102, according to the request by each client PC 102.

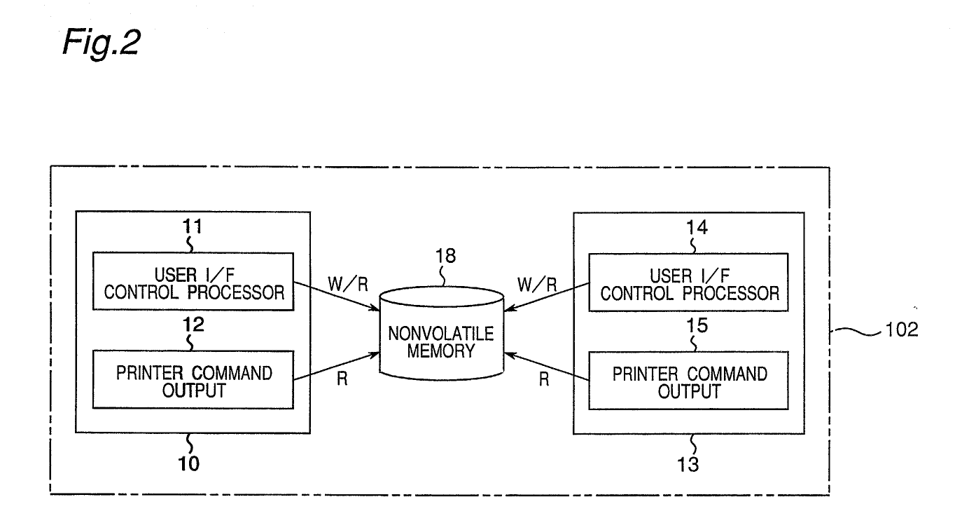

Moreover, each client PC 102 may use a plurality of printers 103, and 104 on the network 100. For the above, printer drivers 10 and 13 (See FIG. 2) are installed on each client PC 102 for recognition of the first and second printers 103 and 104. Various kinds of printing forms, such as layout printing (2 in 1, 4 in 1, and so on), booklet printing, and position shift printing, may be respectively set on the printer drivers 10, and 13.

FIG. 2 shows an explanatory drawing of printer drivers 10 and 13 installed in the client PCs 102 and a configuration relative to the operations of the drivers 10, and 13. The printer drivers 10 and 13 respectively comprises: user interface control processing parts 11, and 14 (hereinafter, called as user I/F control processing parts) for reading and writing of the set information of the printing forms from and into a predetermined memory area; and printer command output parts 12, and 15 for generation of printer commands according to the stored set information.

In the present embodiment, printer drivers 10, and 13, which are different from each other, commonly use a nonvolatile memory 18, as their memory areas for storage of the set information of the printing forms. That is, the set information is written into the common nonvolatile memory 18 installed in the client PC 102 by corresponding user I/F control processing part 11, or 14, when a user sets a printing form using either of the printer driver 10, or 13. The set information stored in the nonvolatile memory 18 is read from the nonvolatile memory 18, whenever the printer driver 10 or 13 is called by the user, and initial setting on the printer drivers 10, and 13 is performed based on the set information.

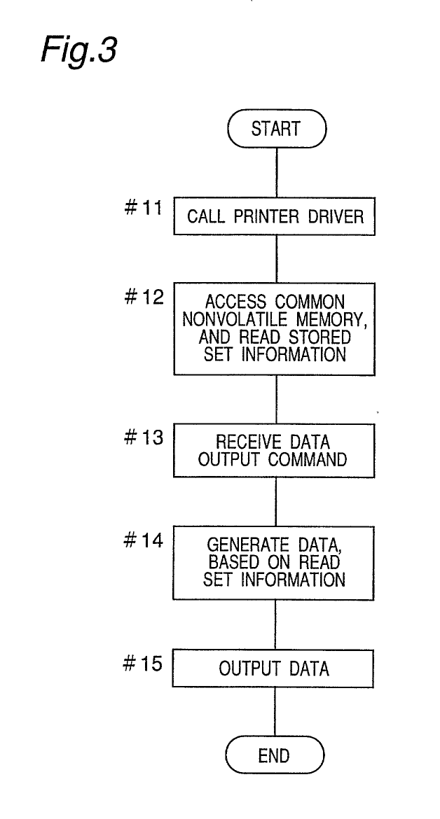

FIG. 3 shows a flow chart for acquisition processing of the set information on the printer driver 10 or 13 which is installed on the client PC 102. In the first place, the printer driver 10 or 13 corresponding to the printer previously set as an output end of the data is called (step #11) in the client PC 102, when printing request from the user is received through, for example, application software. When the printer driver 10 or 13 is called, the user l/F control processing part 11 or 14 accesses the common nonvolatile memory 18 for reading the set information stored at the previous time or before the previous time (step #12).

Then, a command for data output based on the user request is received at step #13. At step #14, data is made based on the set information read at step #12. Thereafter, the data is output to the printer 103 at step #15.

The acquisition processing of the set information is performed based on an operating program installed on the client PC 102. This program is stored in a storage device such as a hard disk drive (not shown) in the client PC 102. Such a program can be installed on the storage device using an external storage medium such as a floppy disk and a CD-ROM.

As described above, setting on one printer driver may be reflected in other printer drivers in the embodiment 1, as printer drivers 10 and 13 which are different from each other are configured to use a common nonvolatile memory 18 as their memory areas for storage of the set information on the printing forms. Thereby, the same printing form with the previous one may be used for printing with no need to change or confirm the set information on the printer driver, when the user switches one printer under use to another one.

Here, the set information may be arbitrarily changed as usual, but the set information after changing is newly written into the nonvolatile memory 18, when printing data is output in a different printing form from the previous one.

Hereinafter, other embodiments according to the present invention will be described.

Embodiment 2

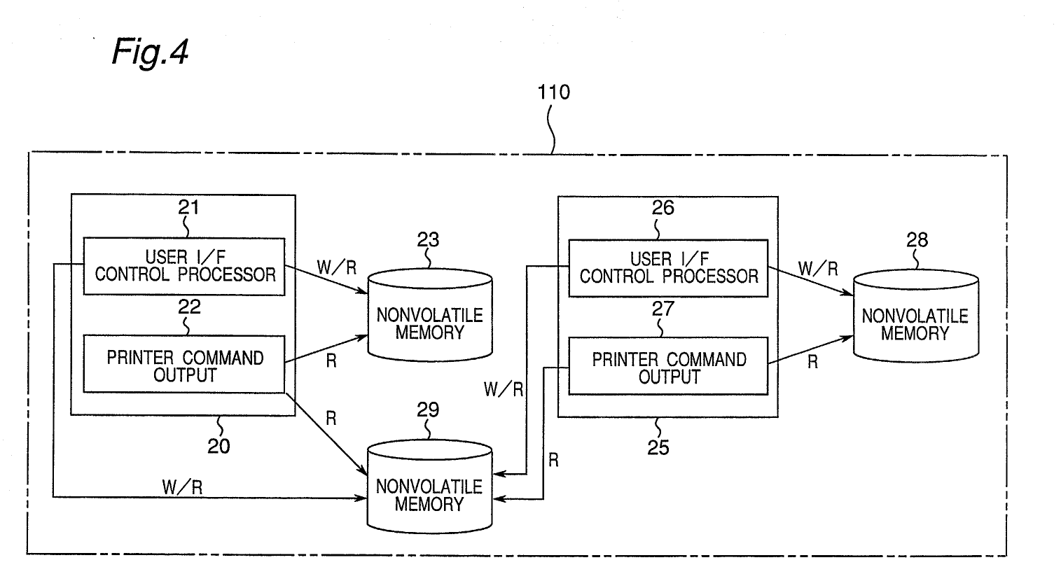

FIG. 4 shows an explanatory drawing of printer drivers 20 and 25 in client PCs 110 (corresponding to the client PC 102) and a configuration relative to the operations of the drivers 20 and 25. The printer drivers 20 and 25 installed in the client PCs 110 respectively comprises: user I/F control processing parts 21 and 26 for reading and writing of the set information of the printing forms from and into a predetermined memory area; and printer command output parts 22 and 27 for generation of printer commands according to the stored set information. The printer drivers 21 and 26 use corresponding nonvolatile memories 23 and 28, respectively, and, at the same time, the common nonvolatile memory 29 in common as their memory areas for storage of the set information for the printing forms.

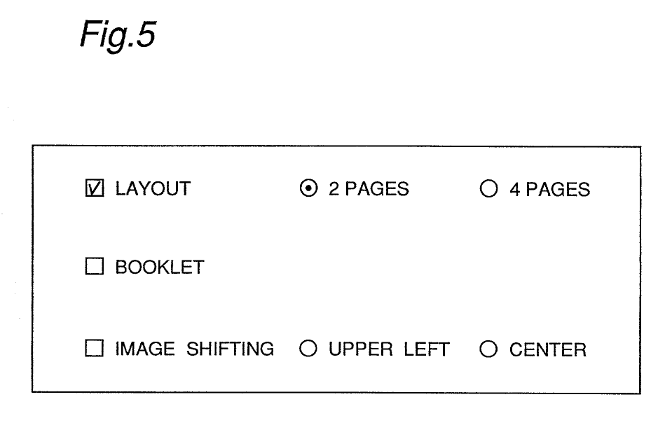

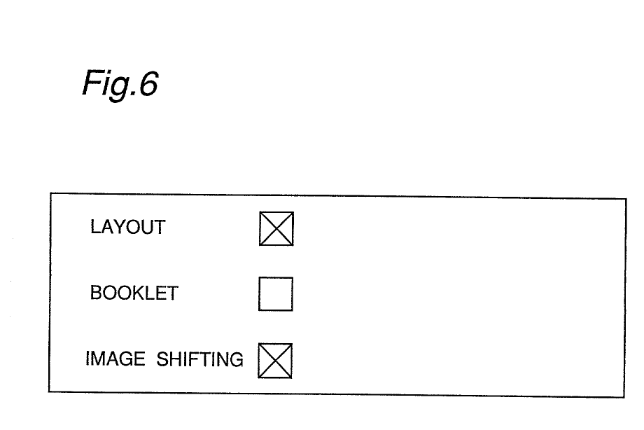

FIGS. 5 and 6 shows a setting screen for printing forms which is provided as a user interface (hereinafter, called as a user I/F) by the user I/F control processing part 21, and 26 of the printer drivers 20, and 25. FIG. 5 shows a setting screen of items that are individually reflected in the printer driver 20 and 25. Here, “Layout”, “Booklet”, and “Image shift” are provided as setting items in the user I/F.

And, FIG. 6 shows a setting screen of items that are stored in the common nonvolatile memory 29. On the setting screen, items, which are reflected on other printer drivers installed on the client PCs 110, may be selected by a user on one printer driver among the items provided on the setting screen shown in FIG. 5. The items that are marked by the user on a setting screen are written into the common nonvolatile memory 29 of the printer drivers 20 and 25. On the other hand, the items which are not made on the setting screen by the user are written into individual nonvolatile memories 23, and 28 for the printer drivers 20 and 25, respectively. In the present embodiment, information for the printing forms, which is reflected in all the printer drivers, may be selectively set as described above.

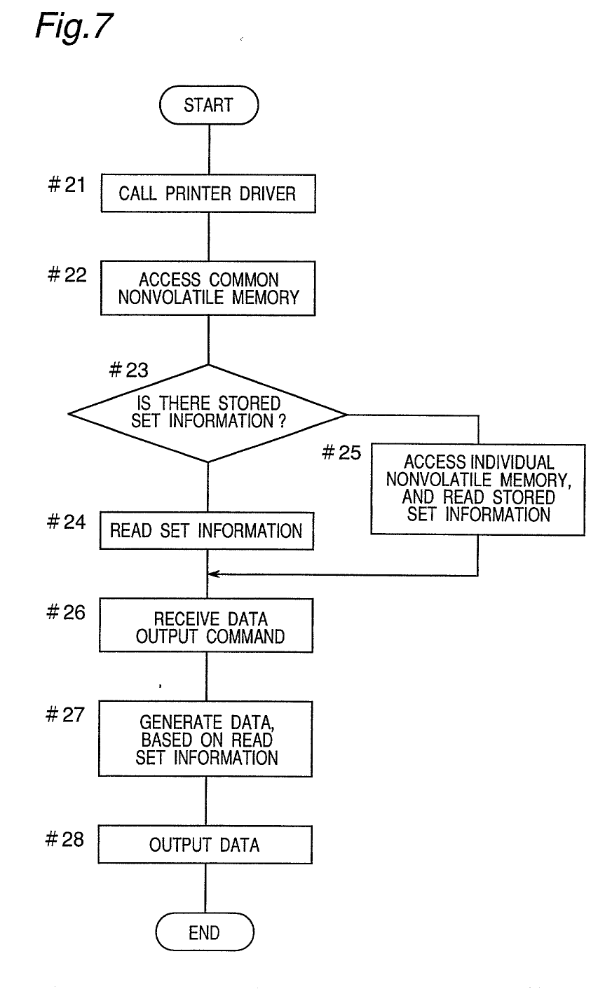

FIG. 7 shows a flow chart for acquisition processing of the set information on the printer driver 20 or 25, which is installed in the client PC 110.

The printer driver 20 or 25 corresponding to the printer 103 previously set as an output end of the data is called (step #21) in the client PC 110, when printing request is received from the user through, for example, application software. When the printer driver 20 or 25 is called, the user l/F control processing part 21 or 26 accesses the common nonvolatile memory 29 (step #22) for confirmation of the existence of the set information stored at the previous time or before the previous time (step #23).

When the set information is stored in the common nonvolatile memory 29 at step #23, the operation proceeds to step #24 for reading the set information stored in the common nonvolatile memory 29. On the other hand, when the set information is not stored in the common nonvolatile memory 29 at step #23, the operation proceeds to step #25 for reading the stored set information after the user I/F control processing part 21 or 26 of the printer driver 20 or 25 have access to the individual nonvolatile memory 23 or 28.

When the data output request is received from the user at step #26, data is made, based on the set information read at step #24 or step #25 (step #27). Then, the data are output to the printer 103 at step #28.

Thereby, the printing forms to be reflected in both printer drivers 20 and 25 may be selectively set in the present embodiment 2 by a configuration where the printer drivers 20, and 25 different from each other use individual nonvolatile memories 23, and 28, respectively, and the common nonvolatile memory 29 in common as their memory areas for storage of the set information on the printing forms, and only the set information for the printing forms selected on the common user I/F is stored in the common nonvolatile memory 29.

Embodiment 3

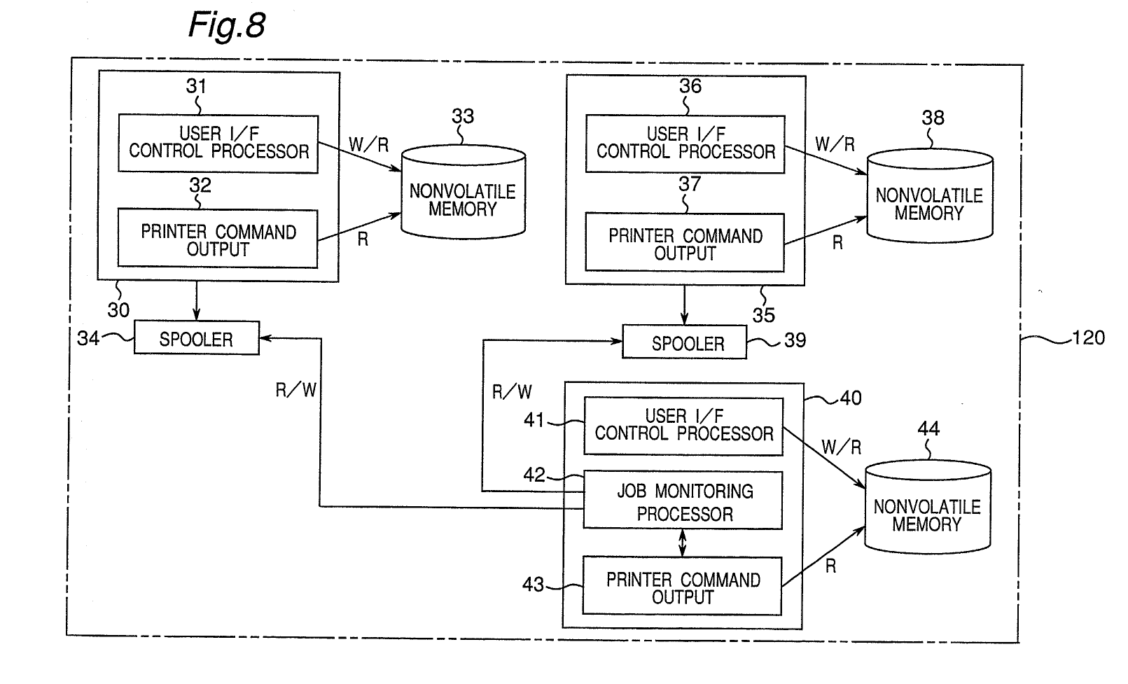

FIG. 8 shows an explanatory drawing of printer drivers 30 and 35 in client PCs 110 (corresponding to the client PC 102 in FIG. 1) and a configuration relative to the operations of the drivers 30 and 35. Printer drivers 30 and 35 are installed on client PC 120 for the printers 103 and 104 on the network 100 (See FIG. 1), and the printer drivers 30 and 35 respectively comprise user l/F control processing parts 31, and 36 for reading and writing of the set information from and into a predetermined memory area; printer command output parts 32 and 37 for generation of the printer commands according to the stored set information. The printer drivers 30, 35 use the corresponding nonvolatile memories 33, 38, respectively, as its memory area for storage of the set information for the printing forms.

Moreover, first and second spoolers 34 and 39 are provided in the client PC 120, as conventionally known, as software for temporary storage of the job data from the printer drivers 30 and 35, and for transmission of data under confirmation of states of the printer 103, and 104.

In the embodiment 3, there is provided in the client PC 120 a resident module 40 for reading the job data from the first and second spoolers 34 and 39, and for conversion of them based on the predetermined set information. The resident module 40 comprises a user I/F control processing part 41; a job watching processing part 42 for watching of the first and second spoolers 34 and 39; and an output conversion filter 43 for analysis of the received job data through the job watching processing part 42.

Moreover, a menu screen to change the set information for printing forms; and a menu screen to select set information reflected on all the printer drivers in the same manner as that of FIG. 6 are provided, as a user l/F by the user I/F control processing part 41, in the present embodiment 3. An on volatile memory 44 is used for the resident module 40, as a memory area where the set information decided with the user l/Fs is stored.

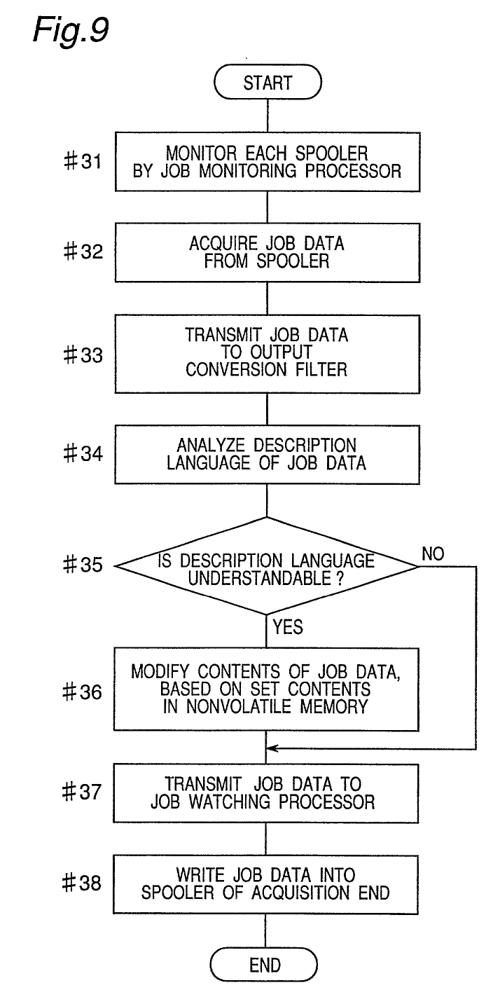

FIG. 9 shows a flow chart for conversion processing of job data made on the printer driver 30 or 35 installed in the client PC 120, based on the predetermined set information.

In the first place, the job watching processing part 42 of the resident module 40 watches the first and second spoolers 34 and 39 provided corresponding to each driver 30 and 35 (step #31) at the use of the printer drivers 30 and 35 in the client PC 120. When job data is input to either of the spooler 34, or 39, the job watching processing part 42 acquires the job data from the spooler 34, and 39 (step #32) for transmission of it to the output job conversion filter 43 (step #33).

The output job conversion filter 43 analyzes the description language of the transmitted job data (step #34). Then, it is judged at step #35 whether the description language is understandable or not. When it is judged that it is understandable, the operation proceeds to step #36 for conversion of the contents of the job data, based on the set information stored in the nonvolatile memory 44. For example, for setting of N-up, when there is a description of

<ESC> N-UP, 0;

(denoting that N-up is not executed)

in the job data, and the nonvolatile memory 44 stores set information of N-up=2 is stored, the description in the job data is changed to the following:

<ESC> N-UP, 2;

After conversion of the job data, the operation proceeds to step #37. On the other hand, when it is judged that it is not understandable at step #35, that is, when there is no identification of the kind of the format of the job data, the operation proceeds directly to step #37 without the conversion. The job data that have been converted, or kept in the original state are transmitted to the job watching processing part 42, at step #37. And, the job data is written into the spooler 34 or 39 that is the acquisition destination at step #38.

As described above, the job data stored in the spooler 34 and 39 are analyzed for the description language in the embodiment 3, and changed based on the set information stored in the nonvolatile memory 44 of the residing module 40, except when the above language is not understandable, that is, except when there is no identification of the kind of the format of the job data. Thereby, it may deal a case where each printer driver 30, 35 installed in the client PC 120 stores set information in a different format, respectively

Embodiment 4

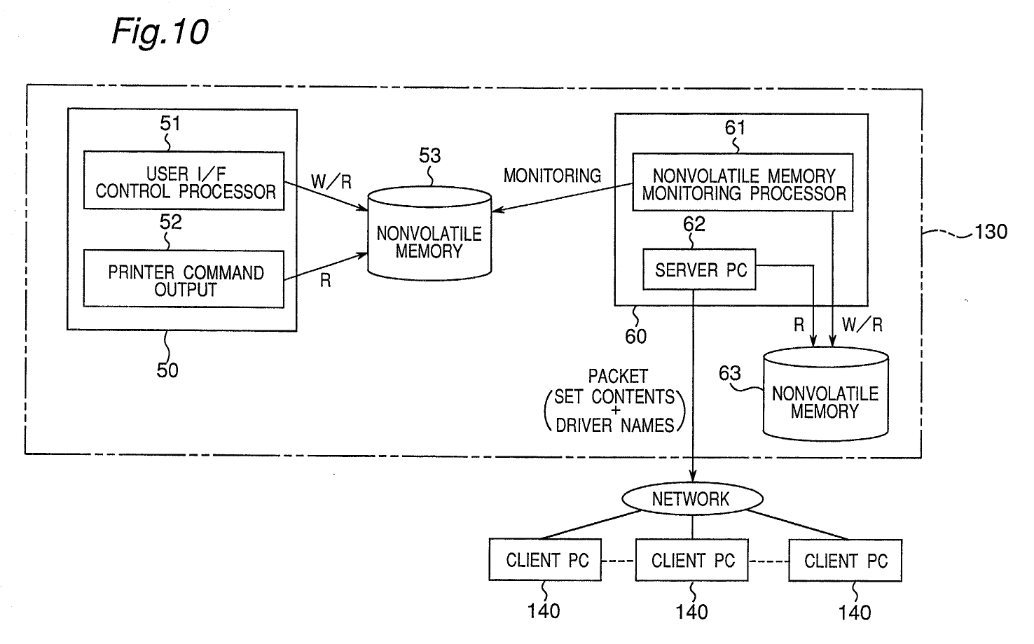

FIG. 10 shows an explanatory drawing of a printer driver 50 in a server PC 130 (corresponding to the server PC 101 in FIG. 1) according to embodiment 4 of the present invention and a configuration relative to the operations of the driver 50. In the embodiment 4, the printer driver 50 is installed on server PC 130 on the network 100, which comprises a user I/F control processing part 51 and a printer command output part 52. The printer driver 50 uses a nonvolatile memory 53 as a memory area storing information for printing forms set on the driver.

Moreover, the server PC 130 is provided with a driver software setting server 60 for reading the latest set information written in the nonvolatile memory 53 for the printer driver 50; and for broadcasting the information to the plurality of client PCs 140 on the network 100. The driver software setting server 60 comprises: a nonvolatile memory watching processing part 61 to watch the nonvolatile memory 53 for the printer driver 50, and to write the latest set information on the printing forms into a predetermined memory area; and a setting server part 62 to read the set information from the memory area where the set information for the printing forms is written in, and to broadcast the information to the plurality of client PCs 140 on the network 100. A special purpose nonvolatile memory 63 is used for the driver software setting server 60 as a memory area for writing the latest set information read from the nonvolatile memory.

The setting server part 62 broadcasts a packet comprising driver names and the set information to the plurality of client PCs 140 on the network 100, when the set information in the nonvolatile memory 63 is changed. The packet comprising the driver names and the set information is transmitted to a client PC 140 through the network 100. In the above case, the setting server part 62 may transmit the packet to a plurality of client PCs 140 at the same time, or only to one client PC 140 requesting the transmission.

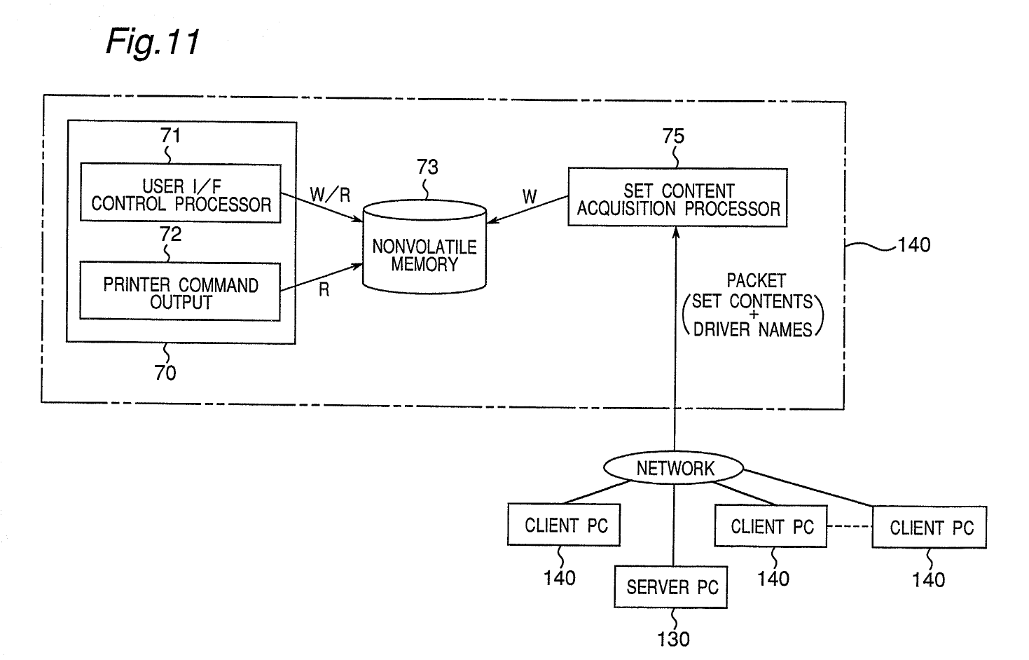

FIG. 11 shows an explanatory drawing of a printer driver 70 in a client PC 140 (corresponding to the client PC 102 in FIG. 1) and a configuration relative to the operations of the driver 70. The printer driver 70 comprises a user I/F control processing part 71 and a printer command output part 72. Here, a nonvolatile memory 73 is used as a memory area of the set information for the printing forms on the printer driver 70. Moreover, there is installed in the client PC 140 a set information acquisition processing part 75 for reception of a packet comprising driver names and the set information from the network 100. The set information acquisition processing part 75 watches the packet broadcast from the server PC 130 through the network 100, and writes it into the nonvolatile memory 73 for the printer driver 70, when the packet comprising the corresponding driver name is received.

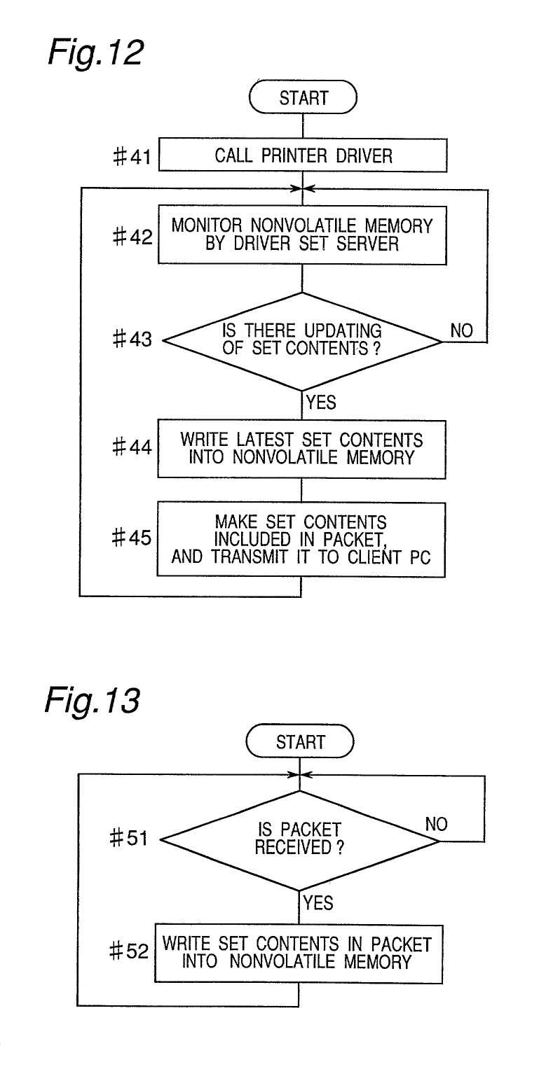

FIG. 12 shows a flow chart for supplying processing of the set information on the printer driver 50 in the server PC 130. In the server PC 130, the driver software setting server 60 starts to watch the nonvolatile memory 53 which the printer driver 50 uses (step #42), when the printer driver 50 is called (step #41). Along with the watching job of the nonvolatile memory 53, it is confirmed whether the set information is updated or not (step #43). When the update of the set information in the nonvolatile memory 53 is confirmed, the updated set information is written into the nonvolatile memory 63 (step #44), and the operation proceeds to step #45.

On the other hand, the operation is returned to step #42, when the update of the set information is not confirmed at step 43, and the watching job of the nonvolatile memory 53 is restarted.

The set information written in the nonvolatile memory 63 is made to be included in the packet, and the packet is distributed to a plurality of client PCs 140 through the network 100 at step #45.

On completion of the distribution of the packet to the client PC 140, the operation is returned again to step #42, and the nonvolatile memory is watched by the driver software setting server 60.

Furthermore, FIG. 13 shows a flow chart for acquisition processing of the set information on the printer driver 70 in the server PC 140. In the first place, it is confirmed in the client PC 140 whether the packet from the server PC 130 is received or not.

When the packet is received, the operation proceeds to #52, and the set information for the packet is written into the nonvolatile memory 73. On the other hand, at step #51, the confirmation of the reception is repeated at step, when the packet is not received.

As described above, information on the printing forms set on the printer driver 50 in the server PC 130 may be automatically copied onto the printer driver 70 in the client PC 140 in the embodiment 4. Thereby, the unified printing forms may be used for the printing system on the network 100.

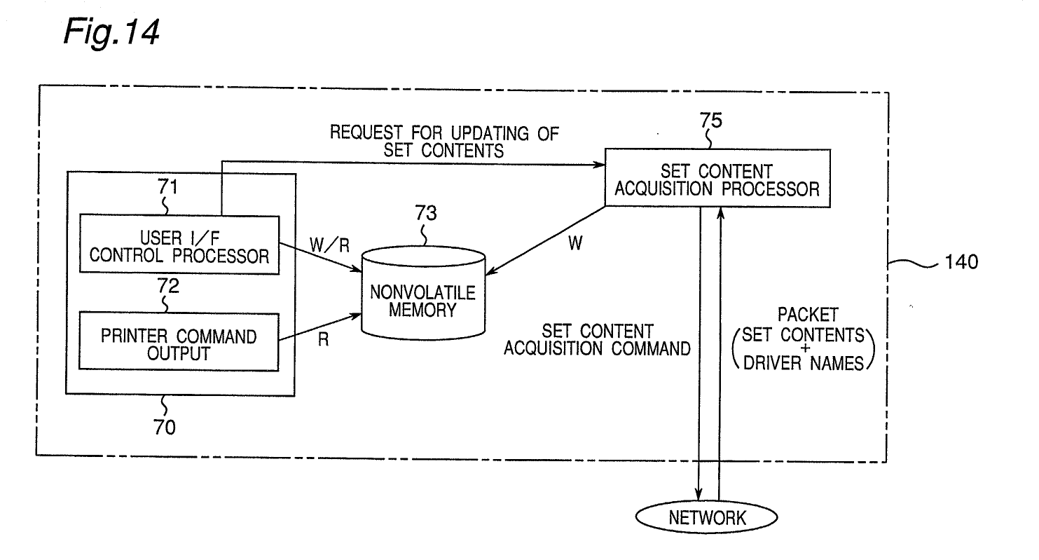

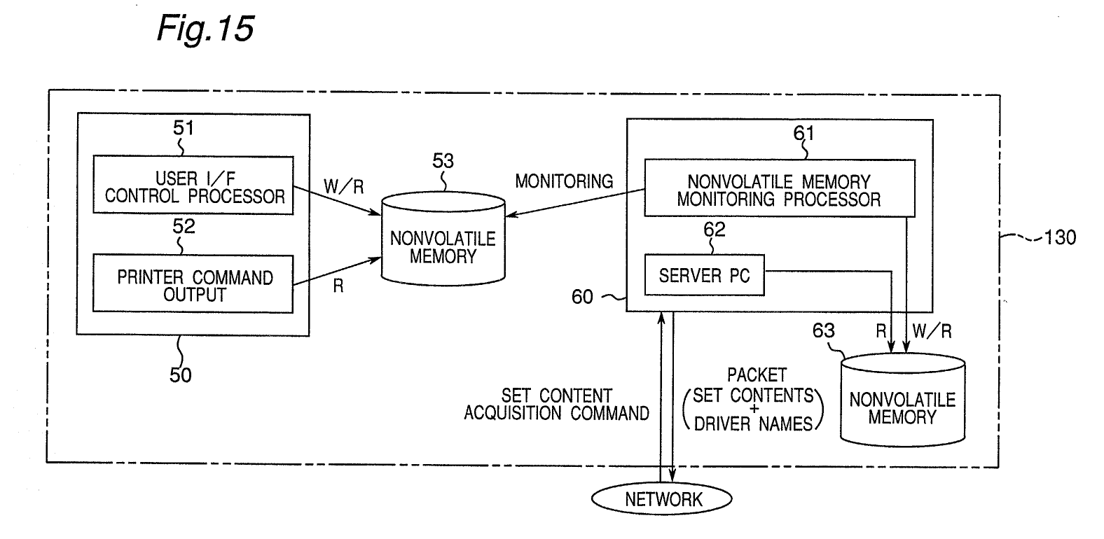

Then, one variation of the embodiment 4 mentioned above will be described. FIG. 14 shows an explanatory drawing of a printer driver 70 in the client PC 140 according to the above variation, and a configuration relative to the operations of the driver 70. The printer driver 70 and other configuration are similar to those of the embodiment 4. In the present variation, the latest set information on the printing forms from the server PC 130 (See FIG. 15) may be received according to the updating request of the set information from users.

That is, the user I/F control processing part 71 of the printer driver 70 asks the set information acquisition processing part 75 for the updating of the set information through sending of a message, or function call on update request of the set information from a user. Responding to the above, the set information acquisition processing part 75 transmits a set information acquisition command to the server PC 130 on the network. Thereafter, the set information acquisition processing part 75 receives the response from the server PC 130, and writes the set information included in the received packet into the nonvolatile memory 73 dedicated only for the printer driver 70.

On the other hand, FIG. 15 shows a view of the printer driver 50 in the server PC 130 according to the above variation of the embodiment 4, and a configuration relative to the operations of the driver 50. The printer driver 50 and other configuration are similar to those of the embodiment 4. Then, in the present variation, the setting server part 62 may receive the set information acquisition command transmitted from the client PC 140 on the network. Further, responding to the received command, the setting server part 62 acquires the latest set information on the printing forms from the nonvolatile memory 63 dedicated only for the driver software setting server 60, and transmits the packet comprising the set information and driver names to the client PC 140 which is the originator of the above set information acquisition command.

Thereby, the printer driver 70 in the client PC 140 may acquire the latest set information on the printing forms from the server PC 130 on the network according to the updating request of the set information from a user.

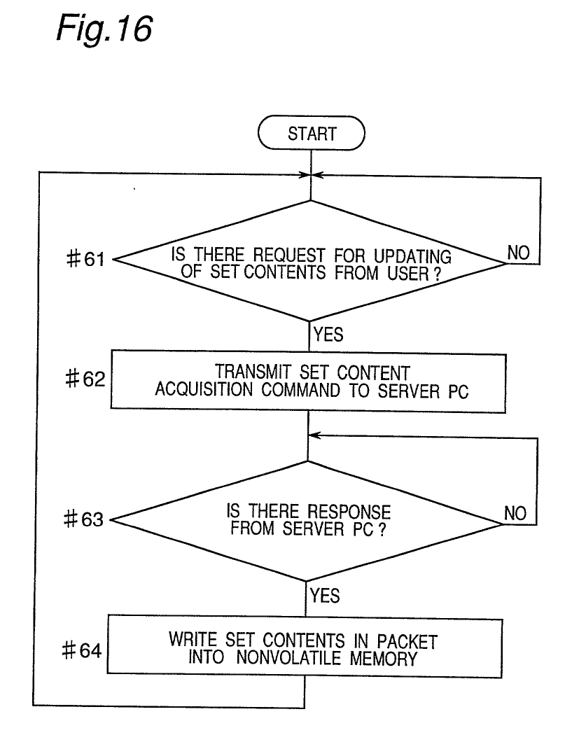

FIG. 16 shows a flow chart for acquisition processing of the set information on the printer driver 70 in the server PC 140 according to the above variation of the embodiment 4. In the first place, the existence of the updating request of the set information from the user is confirmed in the client PC 140 (step #61). When there is the updating request of the set information, the set information acquisition command is transmitted to the server PC 130 (step #62). On the other hand, it is confirmed again whether the existence of the updating request of the set information, when there is no setting requested at step #61.

On completion of transmission of the set information acquisition command, the existence of response from the server PC 130 is confirmed (step #63).

When there is no response from the server PC 130, the existence of the response is confirmed. When there is response from the server PC 130 (that is, the packet comprising the set information), the set information on the printing forms in the received packet is written into the nonvolatile memory 73. Then, the operation is returned to step #61, and the existence of the set information updating request form the user is confirmed.

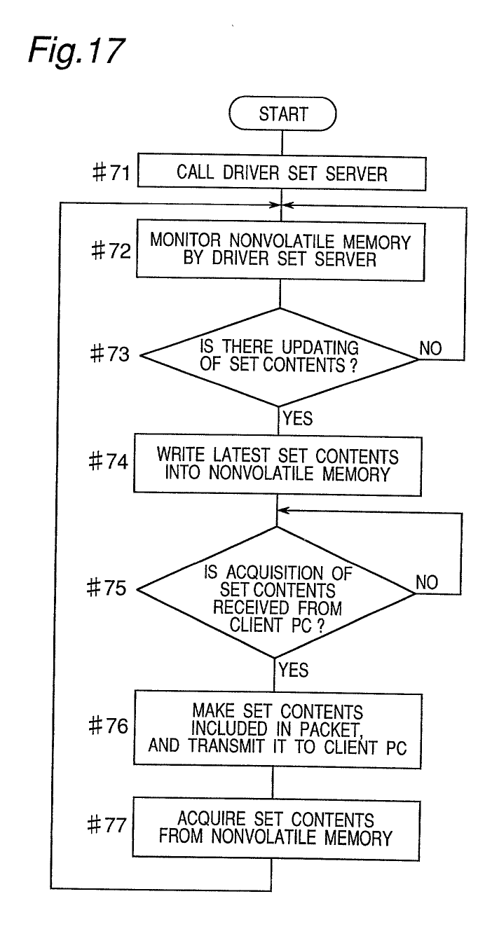

And, FIG. 17 shows a flow chart for supplying processing of the set information on the printer driver 50 in the server PC 130 according to the above variation of the embodiment 4. In the first place, the driver software setting server 60 starts to watch the nonvolatile memory 53 (step #72), when the driver software setting server 60 is called (step #71), in the server PC 130. Along with the watching job of the nonvolatile memory 53, it is confirmed whether the set information is updated or not (step #73). When the updating of the set information in the nonvolatile memory 53 is confirmed, the updated set information is written into the nonvolatile memory 63 (step #74), and the operation proceeds to step #75. On the other hand, when there is no confirmation of the updating of the set information at step #73, the operation proceeds to step #75.

It is confirmed whether the set information acquisition command is received from the client PC 140 at step #75. When the reception of the set information acquisition command is confirmed, the set information corresponding to the command is acquired from the nonvolatile memory 53 (step #76), and the operation proceeds to step #77. The acquired set information is made to be included in the packet, and transmitted to the client PC 140 at step #77.

When the reception of the set information acquisition command is not confirmed at step #75, the operation is returned to step #72, and the nonvolatile memory 53 used for the printer driver 50 is watched.

As mentioned above, the user may perform acquisition of the set information on the printer driver 50 in the server PC 130 at an arbitrary timing in the above variation of the embodiment 4. Thereby, the user own setting of the client PC 140, and the common setting in the printing system on the network 100 may be switched in an arbitrary manner.

Finally, it is obvious that the present invention is not limited to the embodiments described above, and various kinds of modifications and changes in designing may be possible without departing from the scope of the present invention.

1. A data processor to which a plurality of driver software are installed, which controls external devices, and makes data, based on predetermined conditions, for output to said external devices, comprising:
a setting means for setting conditions for reference at making said data on each of said driver software;
a storage device for storing set information on the conditions set by said setting means; and
a controller for controlling to store the set information on each of said driver software in a common storage area, which is commonly used by a plurality of driver software, in said storage device, and to read at using each of said driver software the set information stored in said common storage area which is commonly used.

2. The data processor according to claim 1, wherein said storage device is provided with:
said common storage area for storing set information applied for all the driver software; and
individual storage areas for storing set information applied for each driver software.

3. The data processor according to claim 1, wherein said setting means comprises a selector for selecting set information to be stored in said common storage area for a plurality of conditions which are set on said driver software.

4. The data processor according to claim 1, further comprising:
a watcher for watching a spooler which is installed according to each of said driver software, and temporarily stores job data to be output to said external devices through said driver software; and
a converter for converting the job data, which said watcher acquires from said spooler, according to the set information stored in said storage devices.

5. The data processor according to claim 1, wherein said external device is a printing device, and said driver software is driver software for said printing device.

6. A printing system comprising:
a network server on which a plurality of driver software for control of a printing device is installed, and for making, based on predetermined conditions, data to be output to said printing device;
a plurality of data processors installing said driver software; and
a printing device performing printing of the job data transmitted from said data processor,
wherein said network server transmits a driver name corresponding to an intended driver of the data processors and set information on said driver software to the intended driver of the data processors at using driver software in said data processor.

7. The printing system according to claim 6, wherein said data processor is provided with a requesting device to request at an arbitrary timing the set information on the driver software in said network server, and said network server transmits requested set information to said data processor, responding to requests by said requesting device.

8. The printing system according to claim 6, wherein said network server transmits the set information to a plurality of said data processors.

9. A method of setting control for driver software in a data processor to which a plurality of driver software are installed for control of external devices, and for making, based on predetermined conditions, data to be output to said external devices, comprising steps of:
allowing to set conditions for reference at making said data on each of said driver software;
storing set information on said set condition in a storage area commonly used for a plurality of said driver software; and
reading the set information stored in said storage area commonly used at useing each of said driver software.

10. A method of setting control for driver software in a data processor according to claim 9, further comprising step of a selecting set conditions stored in said storage area commonly used, among a plurality of set conditions.

11. A method of setting control for driver software in a data processor according to claim 9, further comprising step of:
watching a spooler which temporarily stores job data to be output to the external devices through said driver software; and
converting the job data acquired from said spooler according to the set information stored in said storage area.

12. A method of setting control for driver software in a printing system comprising: a network server to which a driver software is installed for control of a printing device, and for making, based on predetermined conditions, data to be output to said printing device;
a plurality of data processors to which said driver software is installed respectively; and
a printing device for performing printing of the job data transmitted from said data processor, the method comprising steps of:
on said network server, transmitting a driver name corresponding to an intended driver of the data processors and the set information for the driver software installed in said network server to said intended driver of the data processors; and
on said data processor, performing to set conditions for the driver software in said data processor based on said set information.

13. A storage medium storing a setting control program for driver software, executed in a data processor to which a plurality of driver software are installed, for control of external devices, and for making, based on predetermined conditions, data to be output to said external devices, the setting control program comprises steps of:
allowing to set conditions for reference at making said data on each of said driver software;
storing set information on said set conditions in a storage area commonly used for a plurality of said driver software; and
reading the set information stored in said storage area commonly used at using said driver software.

14. A storage medium storing a setting control program for driver software, according to claim 13, wherein said setting control program further comprises step of selecting to set conditions stored in said storage area commonly used, among a plurality of setting conditions.

15. A storage medium storing a setting control program for driver software, according to claim 13, wherein said driver software setting control program further comprises steps of:
watching a spooler which temporarily stores job data to be output to external devices through said driver software; and
converting the job data acquired from said spooler according to the set information stored in said storage area.

16. storage medium storing a driver software executed in a printing system comprising:
a network server to which driver software is installed, for control of a printing device, and for making, based on predetermined conditions, data to be output to said printing device;
a plurality of data processors which said driver software is installed respectively; and
a printing device for performing to print the job data transmitted from said data processor, the setting control program comprises steps of:
reading the set information for driver software installed in said network server; and
transmitting a driver name corresponding to an intended driver of the data processors and the read set information for the driver software from said network server to said intended driver of the data processors.
